(19) United States
(12) Patent Application Publication
(10) Pub. No.: US 2024/0289440 A1
(43) Pub. Date: Aug. 29, 2024

(54) METHOD FOR HANDLING THE EXECUTION OF AN APPLET FUNCTION, AND CORRESPONDING LOADING METHOD

(71) Applicant: IDEMIA FRANCE, Courbevoie (FR)

(72) Inventors: Olivier CHAMLEY, Courbevoie (FR); Hugo GRENECHE, Courbevoie (FR)

(73) Assignee: IDEMIA FRANCE, Courbevoie (FR)

(21) Appl. No.: 18/572,296

(22) PCT Filed: Jul. 8, 2022
(86) PCT No.: PCT/FR2022/051377

§ 371 Date: Dec. 20, 2023

(30) Foreign Application Priority Data
Jul. 9, 2021 (FR) FR2107461

(51) Int. Cl. G06F 21/54

(52) U.S. Cl. CPC G06F 21/54

(57) ABSTRACT

A method for handling the execution of an applet function by an electronic device, including receiving a request to execute the function, checking a type associated with the function, if the type of the function is a given type, determining information relating to the arguments that are handled and/or to the data that are delivered by the function, observing the progress of the function and, if the function handles data inconsistently with the information relating to the arguments that are handled and/or to the data that are delivered by the function, performing security handling.

### TECHNICAL FIELD

The invention relates to the execution of functions in electronic devices, and in particular functions whose execution can pose security problems. The invention relates also to the loading of instructions containing these functions in the electronic devices.

### PRIOR ART

The electronic devices such as the chip cards can embed Java Card operating systems. In these operating systems, applets can be executed by virtual machines (“Java Card Virtual Machine”). Indeed, the applications executed by a virtual machine are called applet.

Security mechanisms are provided both outside of the card, for example before the loading of the applet in the card (so-called “off-card” verification), and in the card (so-called “on-card” verification).

Java Card bytecode verification is known which comprises notably off-card verifications on “converted applet” files. This verification consists in verifying the validity of the converted applet files which will be loaded in the cards.

Security problems can arise once the applets are loaded in the cards. In particular, it has been observed that applets can manipulate data which should not be the case.

The invention aims to enhance the security of the execution of the applets.

### SUMMARY OF THE INVENTION

To this end, the invention proposes a method for handling the execution of an applet function by an electronic device comprising:
receiving (for example by the electronic device) a request to execute the function (for example for it to be executed by the electronic device),
verifying (for example by the electronic device) a type associated with the function,
if the type of the function is a given type, determining (for example by the electronic device) information relating to the arguments processed and/or to the data delivered by the function,
observing (for example by the electronic device) the progress of the function (for example when it is executed by the electronic device following the reception of the execution request) and, if the function processes data inconsistently with the information relating to the arguments processed and/or to the data delivered by the function, implementing a security process.

The inventors of the present invention have observed that it is possible to store in the code of the applets information which indicates the arguments that will be processed or the data that will be delivered by a function, to then make it possible to implement a verification.

An inconsistency can comprise a manipulation of data not provided in the information relating to the arguments processed and/or to the data delivered by the function, typically a write in a memory zone that is not provided or a delivery of an object of a type that is not provided.

Furthermore, the inventors have observed that the problems presented hereinabove relate to particular functions (for example of the given type).

According to a particular implementation, the given type is a function which is executed directly on the processor of the electronic device outside of a virtual machine which executes the applet.

It has been observed that the functions which are executed on the processor are generally not tested in the off-card verification, and that these functions manipulate objects outside of the virtual machine, which can be problematic. Detecting these functions is therefore of particular interest.

According to a particular implementation, the given type is a native function and the virtual machine is a Java Card virtual machine.

The invention is well suited to the native functions which are executed on the processor of the electronic device directly and outside of the Java Card virtual machine.

As an indication, in the present application, the Java Card virtual machine is a virtual machine according to the 2021 Java Card Platform version 3.1 (which can be consulted at the following URL

https://docs.oracle.com/en/java/javacard/3.1/index.html). In particular, the specifications can be as follows:

Java Card™ Platform
Virtual Machine Specification, Classic Edition
Version 3.1
February 2021

Java Card™ Platform
Runtime Environment Specification, Classic Edition
Version 3.1
February 2021

Java Card™ Platform
Application Programming Interface, Classic Edition
Version 3.1
February 2021

It will be noted that version 3.1 is backward-compatible with the preceding versions such that the virtual machine can also be in accordance with any of the preceding versions.

According to a particular implementation, the information relating to the arguments processed and/or to the data delivered by the function comprise the type and/or the number of the arguments processed by the function.

According to a particular implementation, the information relating to the arguments processed by the function comprise the type and/or the number of the data delivered by the function.

According to a particular implementation, the steps of verifying the type, of determining the information relating to the arguments processed and/or to the data delivered by the function, and of observing each time a request to execute the function is received, are implemented.

Thus, all the executions of the function will be affected.

The invention also proposes a method for loading an applet in an electronic device comprising:
detecting in the applet a function having a given type,
determining the arguments processed and/or the data delivered by the function,
generating information relating to the arguments processed and/or to the data delivered by the function,
adding in the applet information relating to the arguments processed and/or to the data delivered by the function to obtain a modified applet,
loading the modified applet in the electronic device.

The device that is obtained can be the one capable of implementing the handling method as described hereinabove according to all its embodiments.

According to a particular implementation, the given type is a function which is executed directly on the processor of the electronic device outside of a virtual machine.

According to a particular implementation, the given type is a native function and the virtual machine is a Java Card virtual machine.

According to a particular implementation, the modified applet is a Java Card converted applet.

According to a particular implementation, the information relating to the arguments processed and/or to the data delivered by the function comprise the type and/or the number of the arguments processed by the function.

According to a particular implementation, the information relating to the arguments processed by the function comprise the type and/or the number of the data delivered by the function.

The invention also proposes an electronic device capable of executing an applet function comprising:
a module for receiving a request to execute the function,
a module for verifying a type associated with the function,
a module for determining, if the type of the function is a given type, information relating to the arguments processed and/or to the data delivered by the function,
a module for observing the progress of the function and, if the function processes data inconsistently with the information relating to the arguments processed and/or to the data delivered by the function, a security processing module of the device implements a security process.

This device can be configured to implement all the implementations of the handling method as described hereinabove.

This device can be a chip card, for example a chip card in accordance with the ISO 7816 standard in any of its versions.

The invention also proposes a device for loading an applet in an electronic device comprising:
a module for detecting in the applet a function having a given type,
a module for determining the arguments processed and/or the data delivered by the function,
a module for generating information relating to the arguments processed and/or to the data delivered by the function,
a module for adding in the applet information relating to the arguments processed and/or to the data delivered by the function to obtain a modified applet,
a module for loading the modified applet in the electronic device.

This device can be configured to implement all the implementations of the loading method as described hereinabove.

The invention also proposes a computer program comprising instructions for the execution of the steps of a handling method as defined hereinabove when said program is run by a computer.

The invention also proposes a computer program comprising instructions for the execution of the steps of a loading method as defined hereinabove when said program is run by a computer.

It should be noted that the computer programs mentioned in the present summary can use any programming language, and be in the form of source code, object code, or of intermediate code between source code and object code, such as in a partially compiled form, or in any other desirable form.

The invention also proposes a computer-readable storage medium on which is stored a computer program comprising instructions for the execution of the steps of a handling method as defined hereinabove.

The invention also proposes a computer-readable storage medium on which is stored a computer program comprising instructions for the execution of the steps of a loading method as defined hereinabove.

The storage (or information) media mentioned in the present summary can be any entity or device capable of storing the program. For example, the medium can comprise a storage means, such as a ROM, for example a CD ROM or a microelectronic circuit ROM, or even a magnetic storage means, for example a diskette (floppy disk) or a hard disk.

Also, the storage media can correspond to a transmissible medium such as an electrical or optical signal, which can be routed via an electrical or optical cable, wirelessly or by other means. The program according to the invention can in particular be downloaded over a network of Internet.

Alternatively, the storage media can correspond to an integrated circuit in which the program is incorporated, the circuit being adapted to execute or to be used in the execution of the method concerned.

### BRIEF DESCRIPTION OF THE DRAWINGS

Other features and advantages of the present invention will emerge from the description given hereinbelow, with reference to the attached drawings which illustrate an entirely nonlimiting exemplary embodiment thereof. In the figures:

FIG. 1 schematically illustrates the steps of a handling method according to an example.

FIG. 2 schematically illustrates the steps of a loading method according to an example.

FIG. 3 schematically illustrates the conversion of the code, the loading thereof and the execution thereof.

FIG. 4 schematically illustrates a system with a loading device and an electronic device.

### DESCRIPTION OF THE EMBODIMENTS

Methods for handling the execution of an applet by an electronic device of chip card type, operating with a Java Card operating system that is well known per se to the person skilled in the art, will now be described.

The method P1 of FIG. 1 will be implemented by a microcircuit device, for example a device of Java Card bank card type and therefore with a Java Card virtual machine that can execute Java Card applets.

The invention is nevertheless in no way limited to these cards and is applicable in the devices which execute functions in applets.

In a first step RX_EXEC, a request is received to execute a function, for example by the usual processing of a Java Bytecode by the Java Card virtual machine, that is to say a stream of binary octets which groups together the instructions that can be executed by the virtual machine.

An indicator (that is to say a “flag”) can then be read to determine if the function to be executed is a so-called native function, that is to say one which will be executed outside of the virtual machine on the microcircuit of the device. This step is therefore the step VERIF_TYPE of verifying the type of the function.

If the function is a native function, the step DET_INFO of determining the information relating to the arguments processed and/or to the data delivered by the function are implemented.

For example, such information can comprise the type and/or the number of the arguments processed by the function. Furthermore, such information can comprise the type and/or the number of the data delivered by the function.

As an indication, such information can be contained in an octet (or several octets) in which the types (integer, table, reference, etc.) can be binary-coded. This octet is stored directly in a converted applet file, typically in a “header” of the function. A coding can be chosen according to the application. The one or more octets can notably be stored in the well-known Java Card “nargs” field.

The step OBS of observing the progress of the execution of the function is then implemented. The function is executed and it is verified that it is executed in accordance with what is provided by the information obtained in the step DET_INFO.

If an inconsistency appears, a security process T_SEC is implemented, typically a “Runtime Error” is returned.

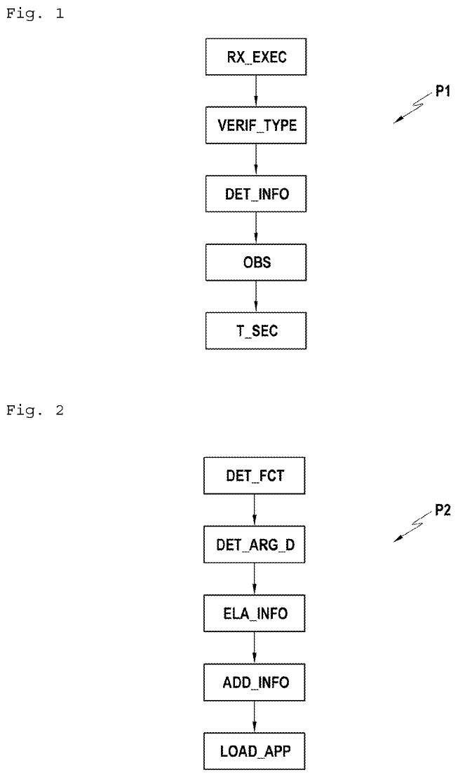

In FIG. 2, a method P2 is represented for loading an applet in an electronic device. This method P2 can be implemented before the method P1 described with reference to FIG. 1.

This method can be implemented after the conversion to converted applet ready to be loaded in a Java Card device.

In the converted applet code, a native function is detected (step DET_FCT). That can be implemented by means of an indicator or “flag” indicating “native” in the header of the function.

Generally, the native functions are identified in the converted code as such.

Next, in the converted code, the arguments processed and/or the data delivered by the function (step DET_ARG_D) are determined. It will be possible to determine their type, their number, etc.

Next, in the step ELA_INFO, information relating to the arguments processed and/or to the data delivered by the function is generated. It is thus possible to form one or more octets by reusing the coding mentioned above.

In the step ADD_INFO, the information obtained in the step ELA_INFO is added in the converted applet, typically in a header and possibly in a Java Card “nargs” field. A modified applet is thus obtained.

The modified applet is loaded in an electronic device in the step LOAD_APP.

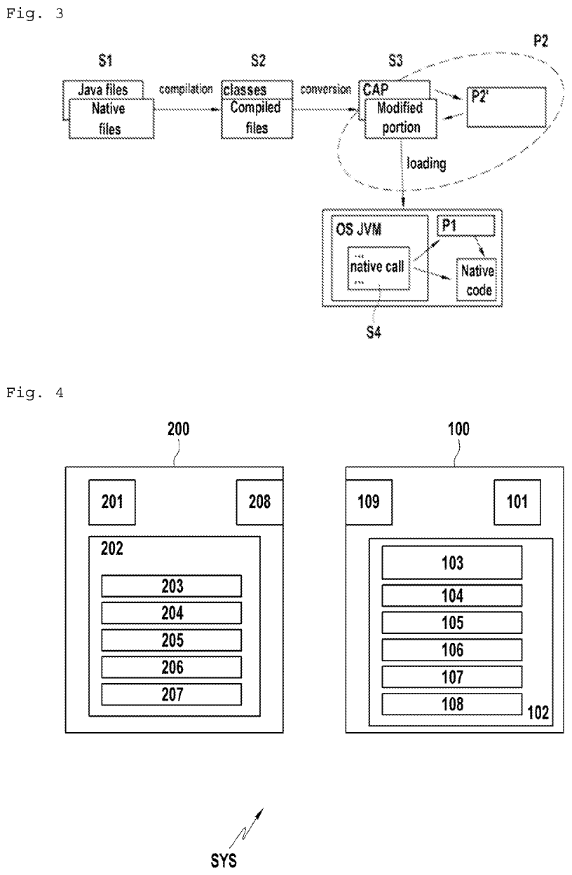

FIG. 3 schematically illustrates how the methods P1 and P2 described with reference to FIGS. 1 and 2 are implemented.

In a step S1, Java files are generated and files are used with native functions.

In a step S2, the files of the step S1 are compiled to obtain classes and compiled files.

In a step S3, the converted files are converted into Java Card applets. The steps DET_FCT, DET_ARG_D, ELA_INFO, and ADD_INFO of the method P2 are then implemented. These steps form the method referenced P2′ in the figure.

The modified code can then be loaded.

In the card, a call to execute a native function is implemented in the step S4. That leads to the implementation of the method P1 of FIG. 1.

In FIG. 4, a system SYS is represented comprising an electronic device 100 of Java Card microcircuit card type, according to the ISO 7816 standard.

This device comprises a processor 101 (or microcircuit) and a non-volatile memory 102 in which instructions 103 for the execution of a Java Card virtual machine are stored.

Furthermore, in the non-volatile memory 102, instructions have been stored which, when they are executed by the processor 101:
implement the step RX_EXEC: instructions 104; the instructions 104 therefore form a module for implementing the step RX_EXEC with the processor,
implement the step VERIF_TYPE: instructions 105; the instructions 105 therefore form a module for implementing the step VERIF_TYPE with the processor,
implement the step DET_INFO: instructions 106; the instructions 106 therefore form a module for implementing the step DET_INFO with the processor,
implement the step OBS: instructions 107; the instructions 107 therefore form a module for implementing the step OBS with the processor,
implement the step T_SEC: instructions 108; the instructions 108 therefore form a module for implementing the step T_SEC with the processor.

Furthermore, the device 100 comprises a communication member 109 by which converted applets can be loaded.

This loading is implemented by a loading device 200 of the system SYS.

This device comprises a processor 201 (or microcircuit) and a non-volatile memory 202.

In the non-volatile memory 202, instructions have been stored which, when they are executed by the processor 201:
implement the step DET_FCT: instructions 203; the instructions 203 therefore form a module for implementing the step DET_FCT with the processor,
implement the step DET_ARG_D: instructions 204; the instructions 204 therefore form a module for implementing the step DET_ARG_D with the processor,
implement the step ELA_INFO: instructions 205; the instructions 205 therefore form a module for implementing the step ELA_INFO with the processor,
implement the step ADD_INFO: instructions 206; the instructions 206 therefore form a module for implementing the step ADD_INFO with the processor,
implement the step LOAD_APP: instructions 207; the instructions 207 therefore form a module for implementing the step LOAD_APP with the processor.

Furthermore, the device 200 comprises a communication member 208 by which converted applets can be sent to a device capable of receiving converted applets.

1. A method for handling the execution of an applet function by an electronic device comprising:
receiving a request to execute the function;
verifying a type associated with the function;
if the type of the function is a given type, determining, by a processor, information relating to arguments processed and/or to data delivered by the function; and
observing, by the processor, progress of the function and, if the function processes data inconsistently with the information relating to the arguments processed and/or to the data delivered by the function, implementing a security process.

2. The method as claimed in claim 1, wherein the given type is a function which is executed directly on the processor of the electronic device outside of a virtual machine which executes the applet.

3. The method as claimed in claim 2, wherein the given type is a native function and the virtual machine is a Java Card virtual machine.

4. The method as claimed in claim 1, wherein the information relating to the arguments processed and/or to the data delivered by the function comprise the type and/or the number of the arguments processed by the function.

5. The method as claimed in claim 1, wherein the information relating to the arguments processed by the function comprise the type and/or the number of the data delivered by the function.

6. The method as claimed in claim 1, wherein the verifying the type, of determining the information relating to the arguments processed and/or to the data delivered by the function, and of observing each time a request to execute the function is received, are implemented.

7. A method for loading an applet in an electronic device, comprising:
detecting in the applet a function having a given type;
determining, by a processor, arguments processed and/or data delivered by the function;
generating information relating to the arguments processed and/or to the data delivered by the function;
adding in applet information relating to the arguments processed and/or to the data delivered by the function to obtain a modified applet; and
loading the modified applet in the electronic device.

8. The method as claimed in claim 7, wherein the given type is a function which is executed directly on the processor of the electronic device outside of a virtual machine.

9. The method as claimed in claim 8, wherein the given type is a native function and the virtual machine is a Java Card virtual machine.

10. The method as claimed in claim 7, wherein the modified applet is a Java Card converted applet.

11. The method as claimed in claim 7, wherein the information relating to the arguments processed and/or to the data delivered by the function comprise the type and/or the number of the arguments processed by the function.

12. The method as claimed in claim 7, wherein the information relating to the arguments processed by the function comprise the type and/or the number of the data delivered by the function.

13. An electronic device capable of executing an applet function comprising:
a module for receiving a request to execute the function;
a module for verifying a type associated with the function;
a module for determining, if the type of the function is a given type, information relating to arguments processed and/or to data delivered by the function; and
a module for observing progress of the function and, if the function processes data inconsistently with the information relating to the arguments processed and/or to the data delivered by the function, a security processing module of the device implements a security process.

14. A device for loading an applet in an electronic device comprising:
a module for detecting in the applet a function having a given type;
a module for determining arguments processed and/or data delivered by the function;
a module for generating information relating to the arguments processed and/or to the data delivered by the function;
a module for adding in applet information relating to the arguments processed and/or to the data delivered by the function to obtain a modified applet; and
a module for loading the modified applet in the electronic device.

15. (canceled)

16. A non-transitory computer-readable storage medium on which is stored a computer program comprising instructions for the execution of the steps of a handling method as claimed in claim 1.

17. (canceled)

18. A non-transitory computer-readable storage medium on which is stored a computer program comprising instructions for the execution of the steps of a loading method as claimed in claim 1.

19. The method as claimed in claim 2, wherein the information relating to the arguments processed and/or to the data delivered by the function comprise the type and/or the number of the arguments processed by the function.

20. The method as claimed in claim 2, wherein the information relating to the arguments processed by the function comprise the type and/or the number of the data delivered by the function.

21. The method as claimed in claim 3, wherein the information relating to the arguments processed by the function comprise the type and/or the number of the data delivered by the function.

22. The method as claimed in claim 4, wherein the information relating to the arguments processed by the function comprise the type and/or the number of the data delivered by the function.
